(19) United States
(12) Patent Application Publication
(10) Pub. No.: US 2004/0225955 A1
(43) Pub. Date: Nov. 11, 2004

(54) Intelligent information dashboard system and method

(75) Inventor: Sidney Ly, Seattle, WA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: The Boeing Company

(21) Appl. No.: 10/834,702

(22) Filed: Apr. 29, 2004

Related U.S. Application Data
(60) Provisional application No. 60/468,933, filed on May 8, 2003.

(51) Int. Cl. G06F 17/00

(52) U.S. Cl. 715/500

(57) ABSTRACT

An intelligent information dashboard system is provided. The system collects, manages, and presents data and information to allow decision making from real-time information based on data from any number of sources. Three functional layers combine to create the intelligent information dashboard system. The top layer is a software application for designing and displaying the information. The middle layer is a data management layer for data propagation and aggregation. The bottom layer, the intelligent dashboard agent, is for data collection and processing. Because the intelligent information dashboard system includes functional layers, it can easily and quickly be adapted to present different information in any business application as desired or needed. In one example, the top layer of the intelligent information dashboard system is a web-based dashboard module for presentation of the information collected by intelligent dashboard agents and managed by a dashboard management layer.

### CROSS REFERENCE TO RELATED APPLICATION

This application claims priority to and the benefit of the filing date of provisional application entitled “Intelligent Information Dashboard System and Method,” assigned Ser. No. 60/468,933 and filed May 8, 2003, which is hereby incorporated by reference.

### FIELD OF THE INVENTION

The present invention relates generally to data presentation systems and methods, and, more particularly, to web-based dashboard software applications for real-time presentation of business information, data management systems, and information agents.

### BACKGROUND OF THE INVENTION

Most business operations, especially those in manufacturing and supply, cannot be efficiently without enabling people who manage them with accurate, real-time and easy-to-understand information from all relevant sources. Conventional retrieval of information is often done manually which is difficult and time-consuming. Information collected in this manner is generally not timely, making it less likely to be a dominant factor for making and running business operations.

Any decision made without current information, particularly crucial information at a given moment, can be, and often is, a wrong decision. An uninformed decision can reduce operational efficiency, productivity, and competitiveness. A wrong decision or a plurality of uninformed decisions have the potential to cripple a business.

Information systems have been developed to analyze business systems and manufacturing processes. At the present time, information systems providing beneficial information normally have a steep learning curve to operate and use, are customized to a single application, and are expensive. Conventional systems are designed as a standalone hardware and software product for a specific use and, typically, cannot easily be adapted for additional uses.

### SUMMARY OF THE INVENTION

The present invention provides an intelligent information dashboard system (IIDS) for presenting information. The system can be used in business operations to make critical decisions from information in real-time based on data from any number of sources. This presentation of information allows managers and other decision-making personnel to diagnose and deal with business issues in real-time with up-to-date information. The invention can be used to link business, manufacturing process, and asset data together in real-time to create a visual presentation of information.

Three functional layers combine to create the intelligent information dashboard system of the present invention. The top layer is a software application for designing and displaying the information by dashboard presentation modules. The middle layer, the Universal Data Collection System (UDCS) of this data management layer, is a management module for data propagation and aggregation. The bottom layer, the dashboard agent layer, is a collection of intelligent dashboard agents (IDAs), or data-mining modules, for data collection and processing.

The layered design allows the intelligent information dashboard system to integrate processes and technology by generating, gathering, and displaying data in an efficient information presentation. Because the intelligent information dashboard system is comprised of functional layers, it can easily and quickly be adapted to present different information in any business application as desired or needed. The system becomes familiar because its use is not limited to a single application, thereby reducing an associated learning curve. The customization is limited to defining what data is desired in the presentation and the mode of presentation of the information. These features, individually and together, make the intelligent information dashboard system an inexpensive business tool.

In one exemplary embodiment of the present invention, the top layer of an intelligent information dashboard system is a web-based dashboard software application providing the visual design and display of the information. A top layer may accept input from a user or may process the data to create feedback to the lower layers. Feedback from input or data processing may be used for remote notification of system, process, or device status or may be used to control a process or device.

In another exemplary embodiment of the present invention, the collected data from an intelligent dashboard agent module is passed to the data management module through data tunnels. One or more data tunnels may be aggregated by the dashboard management module to create aggregate data tunnels, and aggregate tunnels may be compounded or combined with additional data tunnels to create higher order data tunnels or hyper-aggregated data tunnels. In such a manner, data may be synchronized with other data sources through aggregated or hyper-aggregated data tunnels or may be transmitted via independent data tunnels. A data management module may use a software kernel to manage data between an agent module and a presentation module. Data flow to and from a data management module maybe controlled by data valves, such as using passwords to authenticate credentials for providing or receiving data from the system.

In another exemplary embodiment of the present invention, an agent module or agent thereof may format, process, or filter data before providing the data to the data management module. Similarly, a presentation module may format, process, or filter data for consumption a user.

Additional exemplary embodiments of the present invention provide associated methods and computer program products representative of the characteristics described above.

### BRIEF DESCRIPTION OF THE DRAWINGS

Having thus described the invention in general terms, reference will now be made to the accompanying drawings, which are not necessarily drawn to scale, and wherein:

FIG. 1 is a flow chart diagram of an intelligent information dashboard system of one embodiment of the present invention;

FIG. 2 shows a block diagram of an intelligent information dashboard system for a factory of one embodiment of the present invention;

FIG. 3 shows a dashboard presentation module of an intelligent information dashboard system for production of skin mills of one embodiment of the present invention;

FIG. 4 shows a dashboard presentation module of an intelligent information dashboard system for a flow scorecard of one embodiment of the present invention;

FIG. 5 shows a dashboard presentation module of an intelligent information dashboard system for job kit delivery requests of one embodiment of the present invention;

FIG. 6 shows a dashboard presentation module of an intelligent information dashboard system for a cutting tool service center of one embodiment of the present invention;

FIG. 7 shows a dashboard presentation module of an intelligent information dashboard system for a final assembly moving line of one embodiment of the present invention;

FIG. 8 shows a dashboard presentation module of an intelligent information dashboard system for GPS tracking of one embodiment of the present invention;

FIG. 9 shows a visual design module for an intelligent information dashboard system of one embodiment of the present invention;

FIG. 10 shows a block diagram of a universal data collection system of a dashboard data management layer of one embodiment of the present invention;

FIG. 11 shows a diagram of the security provided by a universal data collection system of one embodiment of the present invention;

FIG. 12 shows a diagram of different types of data tunnel modes of operation;

FIG. 13 shows a diagram of tunnel mirroring;

FIG. 14 is an example of tunnel mirroring;

FIG. 15 shows a diagram of a software agent;

FIG. 16 is a diagram of a data driven sequential process;

FIG. 17 is an example of a data driven random, or asynchronous, process;

FIG. 18 shows a block diagram of data synchronization support of a universal data collection system of one embodiment of the present invention; and

FIG. 19 is a block diagram of a hardware and software system of an embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

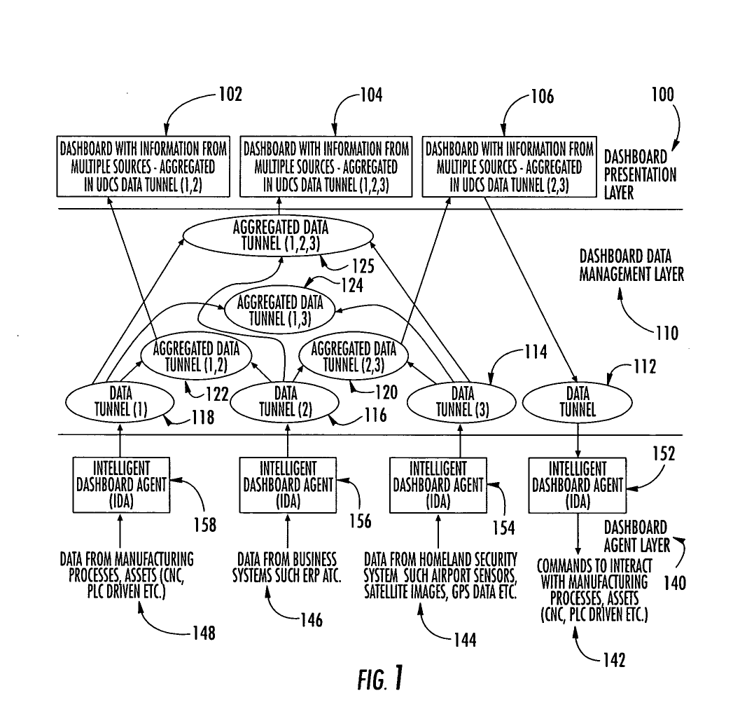

FIG. 1 shows a flow chart diagram of an intelligent information data system of one embodiment of the present invention. Each of the three layers, the top or dashboard presentation layer 100, the middle or dashboard data management layer 110, and the bottom or dashboard agent layer 140, are shown in FIG. 1. The dashboard agent layer 140 is the bottom layer which includes intelligent dashboard agents 154, 156, 158 that provide the means by which data is obtained from data sources 144, 146, 148 and provided to the dashboard data management layer 110. An intelligent dashboard agent (IDA) can record data from a data source and publish information to a dashboard data management layer without any modification to the data, or an intelligent dashboard agent can modify or adapt any of the data recorded from a data source such that the data published to a dashboard data management layer is appropriate to what a designer wants an intelligent dashboard agent to provide to the data management layer and subsequently to a user at a dashboard presentation layer. For example, data can be processed by any type of data mining, filtering or other algorithm that is desired of the data source. Additionally, or alternatively, the dashboard agent layer may format or process the information, as desired, prior to displaying on the dashboard.

The dashboard agent layer 140 allows the intelligent information dashboard system to interact with different data sources. These data sources can be any type of data source. For example data can be collected from hardware or manufacturing processes and assets 148. Data can be collected from business systems such as enterprise resource planning systems that may collect or store information related to a business 146. Data can be collected from sources such as homeland security systems including airport sensors, satellite images, and GPS data 144.

Each intelligent dashboard agent 154, 156, 158 of the dashboard agent layer 140 creates data that is published into the dashboard data management layer 110. The data from an intelligent dashboard agent 154, 156, 158 can be considered a data tunnel 114, 116, 118 in the dashboard management layer 110. The data that is provided to a dashboard management layer as the data is published from an intelligent dashboard agent is created by an intelligent dashboard agent in such a way that the data is intended for the end user to view via a dashboard presentation layer. The designer of the intelligent dashboard agent processes the data from the data source in such a way that the data can become information that is actionable and understood by the user of the dashboard presentation layer. Therefore, a data management layer need not modify the data, but only manages the data.

Each data tunnel that is published from an intelligent dashboard agent into the dashboard data management layer can be subscribed to by a user of a dashboard presentation layer. The dashboard data management layer may also aggregate data from two separate data tunnels into an aggregated data tunnel. As seen in FIG. 1, data tunnel 1 118 and data tunnel 2 116 are combined into an aggregated data tunnel 122. Similarly an aggregated tunnel 120 is created for data tunnel 2 116 and data tunnel 3 114. Although not shown, aggregated data tunnels can be combined into a cumulative aggregated data tunnel. A dashboard data management layer can consist of any number of original data tunnels from data sources.

Each data tunnel may be created with a password and user name such that someone subscribing to a data tunnel must know the appropriate password and user name in order to access that tunnel. Therefore, the dashboard data management layer may provide security such that when data is provided to the dashboard data management layer only those users of dashboard presentation layers that have the appropriate credentials can acquire the data that has been provided to the dashboard data management layer. In other words, the data tunnels that are published to the dashboard data management layer are not open to be subscribed to by any user of a dashboard presentation layer. In this manner, the intelligent information dashboard system of the present invention provides the ability of different users to see different data sources or different combinations of all of the data tunnels of a dashboard data management layer.

The aggregation of data tunnels in the dashboard data management layer 110 is done automatically without knowledge by either the intelligent dashboard agent 140 or the dashboard presentation layer 100 about how the data was brought together. This is done so that the top layer or dashboard presentation layer 100 can operate efficiently and reliably by allowing for real time presentation of information. The data from the manufacturing processes and assets and other data sources is shown and presented on the top layer in real time as it occurs 102, 104, 106 such that someone making decisions from the dashboard presentation layer can make accurate decisions based on the information presented. Thus, the information is actionable information rather than just historic data. The unique nature of the three-layered architecture of the present invention allows the dashboard agent 140 and presentation 100 layers to operate independently while the intelligent information dashboard system combines these layers using the middle dashboard data management layer 110.

The processing and formatting of the data by the dashboard agent layer is the business logic that is uniquely implemented for each specific combination of a data source and the information presented for a user of a dashboard presentation layer. Therefore, an intelligent dashboard agent can be made to satisfy any real-time viewing requirement for any type of data source including, but not limited to, manufacturing operations, business operations, and security operations. Also, as shown in FIG. 1, an intelligent dashboard agent 152 has the responsibility to process any interactive information sent back to the dashboard agent layer 140 by the dashboard presentation layer 100 through the data management layer 110 such as business logic or user interaction, such as commands to interact with manufacturing processes or assets 142.

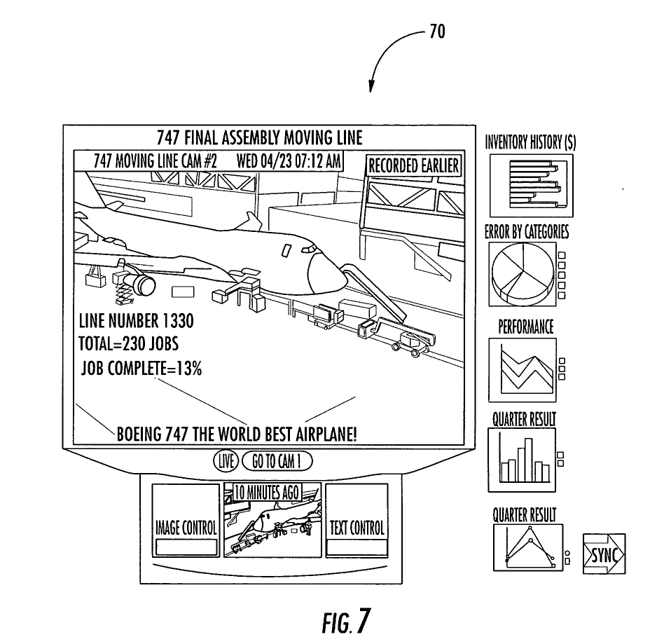

The top layer or dashboard presentation layer 100 is where all of the data source information comes together in a format that can be understood and used by a user. The information can be presented in any number of formats including, but not limited to, charts, graphs, textual, and numerical information. A visual design tool 90 is used to create individualized dashboard presentation modules as shown in FIG. 9, such as the dashboard presentation modules 102, 104, 106 shown in FIG. 1. The visual design tool 90 allows any type of object to be presented on a given dashboard presentation module. Each dashboard presentation module can subscribe to data tunnels or aggregated data tunnels from the dashboard data management layer for which the dashboard presentation module has appropriate credentials, user name and password.

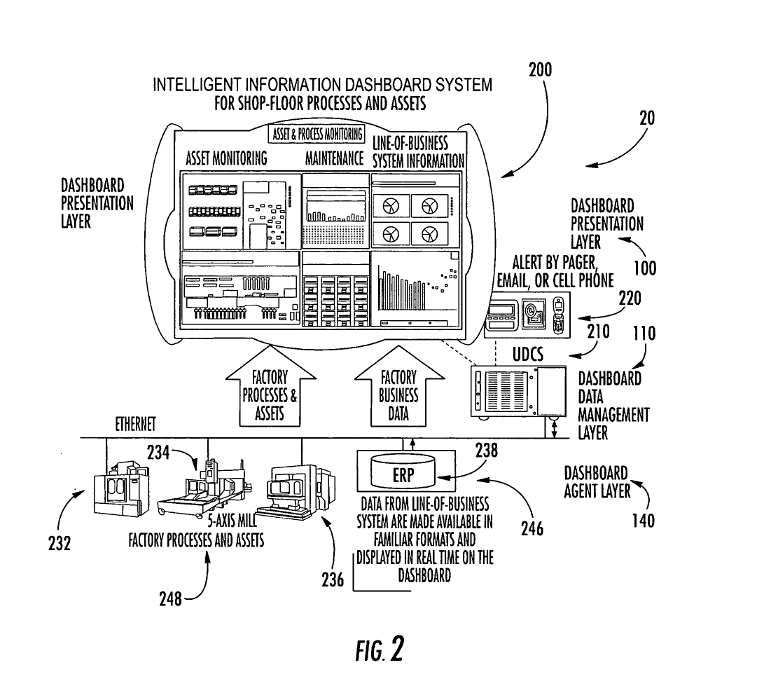

As shown in FIG. 1, a dashboard presentation module can receive user interaction and provide data to the dashboard management layer, as would an intelligent dashboard agent, by creating a data tunnel 112 through which data can be routed to and used by an intelligent dashboard agent 152. Such outgoing information or data 142 can be used, for example, to interact with a manufacturing process or business system. This outgoing information 142 may also be outgoing activity such as notifying an individual of information by way of an e-mail, a pager, or other information signal 220 of the outgoing data to an external information device, as shown in FIG. 2.

The dynamic objects of a dashboard presentation module, such as bar charts or pie charts of a visual display, are driven by the data that comes from the intelligent dashboard agents of the dashboard agent layer and through the dashboard management layer. An individual designing an end user presentation module may select the data the user wants to see and to display as information presented on the dashboard presentation module. All of the orchestration of data is done automatically through the middle dashboard data management layer for presentation on the top layer.

FIG. 2 shows a block diagram of an intelligent information dashboard system 20 for a factory. The bottom layer, represented by the dashboard agent layer 140, shows incoming data from factory processes and assets 248 and from enterprise resource planning (ERP) 246. Incoming data can be collected directly from machines or physical hardware 232, 234, 236 or from any other type of data source such as the ERP 238. The middle layer or data management layer 110 is shown in FIG. 2 as the universal data collection system (UDCS) 210. The information from the dashboard agent layer 140 is provided to the middle layer such that the data from each of the individual data sources can be provided to the dashboard presentation layer 100 or aggregated into cumulative data tunnels that provide information to the dashboard presentation layer 100. The dashboard presentation layer 110 is presented in FIG. 2 as a web-based visual display of information 200 from the data provided by the different assets 232, 234, 236 and other data sources 238 of the dashboard agent layer 140. The visual presentation of information on the dashboard presentation layer 100 can be seen as pie charts, bar charts, or other textual or visual representations of data as information that can be used to make decisions. A dashboard presentation module may include logic to format and/or process data obtained via the data management layer for the various charts, text, and other objects that are presented in the dashboard presentation layer. This logic may be referred to as dashboard presentation logic and may be specific to one or more dashboard presentation modules by comparison to formatting or processing that occurs at the intelligent dashboard agent layer. The data that is provided via an intelligent dashboard agent layer is specific to data sources, and although the data management layer does not operate with respect to the specific type, manner, or format of the information, objects of a dashboard presentation module are designed in accordance with the specific format and other characteristics of the data provided for each data source.

Also shown in FIG. 2 is that data can be used automatically or by input from the user to provide communication interaction from the top or middle layer to the middle or bottom layer, respectively. For example, based on algorithms or formulae, information can be sent from the universal data collection system 210 to an external information device such as an e-mail client, cell phone, or pager 220. This feature could be used when criteria is met by data provided by an intelligent dashboard agent 246, 248 or when information is provided by a user from the dashboard presentation layer 100 that a certain action should be taken or to provide data that can be used as a separate data tunnel. For example, if a temperature reaches a certain critical level, the flexibility of two-way communication of an intelligent information dashboard system of the present invention makes it possible to automatically turn the temperature down or turn the system off or allow a user to selectively turn the temperature down or turn the system off.

Because the intelligent information dashboard system can be presented in a dashboard presentation layer that is a web-based system, it can be implemented on any computing platform with just a web browser installed. Other features of the dashboard presentation layer being a web-based system are the ability of users to view information remotely and the ability for different remote viewers to collaborate on the design of the information to be presented on a dashboard presentation module. A dashboard presentation module can be seen by remote users on their web browsers automatically and in real time as it is developed and designed and once it has been created. An intelligent information dashboard system and dashboard presentation module can also be networked on an intranet or locally as a software application. The broader the range of data publishing and subscription, the wider the range of data source and user interaction with an intelligent information dashboard system. Information presented on a dashboard can be used, for example, to allow a factory supervisor to respond to problems or changes quickly before the problem or change causes an uncontrollable impact upon the business or production. This may enable a business to have a competitive business strategy by taking advantage of up-to-date and accurate information.

The ability of the dashboard presentation layer to allow a user to interact with the middle or bottom layers is due to the fact that the intelligent information dashboard system hosts interactive objects that provide a human-machine interface to feed data back to an intelligent dashboard agent. The user interaction at the dashboard presentation layer supplies data just as if it were another data source into the universal data collection system, and an agent on the bottom layer can then accept the data from the universal data collection system. Thus, the intelligent information dashboard system of the present invention allows for two-way communication from the dashboard agent layer 140 to the dashboard presentation layer 100 and from the dashboard presentation layer 100 to the dashboard agent layer 140 by way of the dashboard data management layer 100.

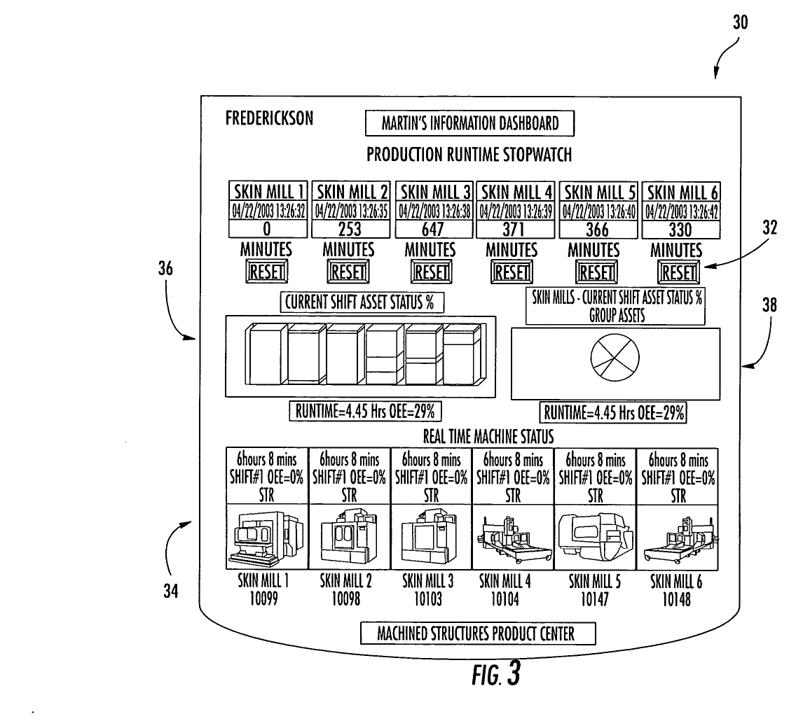

FIG. 3 shows a dashboard presentation module 30 of an intelligent information dashboard system for production of skin mills. The dashboard 30 has been configured to display data that is provided from six separate skin mills. The data from each of the machines 34 is presented on the dashboard presentation module 30 in real time, showing the statistics or status for each machine. Although not shown, the data is provided by an intelligent dashboard agent for each machine that publishes a data tunnel to the dashboard management layer from which the data tunnel can be subscribed to by the dashboard presentation module of FIG. 3. As seen in FIG. 3, a dashboard presentation module can be designed to include text to put the information displayed on the presentation module into context for the user. For example, the status of each of the skin mills is presented under a title Real-Time Machine Status and the runtime for each of the six skin mills is presented underneath a title of Production Runtime Stopwatch. The entire presentation module 30 of FIG. 3 is labeled as Martin's Information Dashboard. Additional text is presented on the bottom of the module with a notation that the information presented is related to the Machined Structures Product Center of The Boeing Company.

A user can interact with the information or data presented on the presentation dashboard as seen in the upper portion of FIG. 3 where the user can reset the production run-time stopwatch for any of the six skin mills that are presented on the presentation dashboard 30 by selecting or depressing a Reset button 32 on the presentation dashboard 30.

FIG. 4 shows a dashboard presentation module 40 of an intelligent information dashboard system for a flow scorecard. The display shows textual labels that this flow scorecard is related to a 737 final assembly. Bar charts are provided for the first shift and second shift on the top of the display with additional related information presented in the middle bottom of the display. As can be seen from the date and time reference 42 at the middle of the bottom of the display, the information presented by this presentation module is presented in real-time as the information is provided by an intelligent dashboard agent to the data management layer to the presentation module.

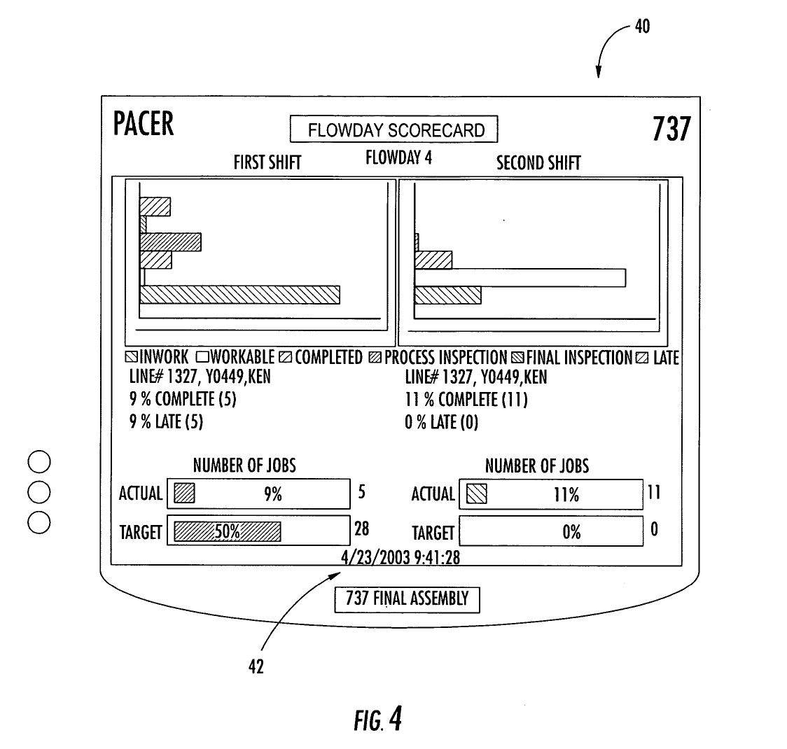

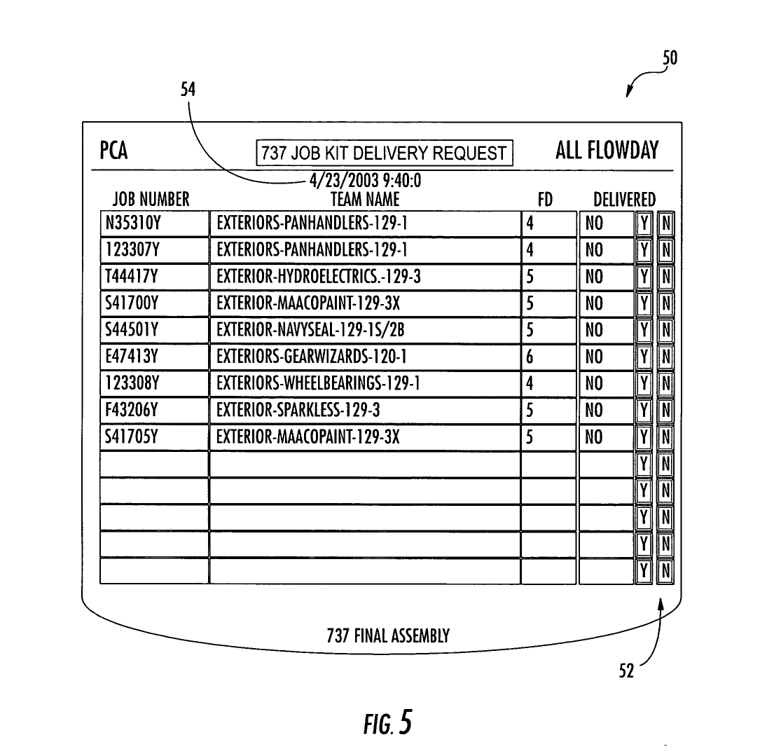

FIG. 5 shows a dashboard presentation module 50 of an intelligent information dashboard system for a job kit delivery request. This is another example of how different types of information can be presented to a user on a dashboard presentation module of the present invention. The dashboard presentation module 50 presented in FIG. 5 displays information about different jobs, the teams which are handling the jobs, and an indication as to whether or not that job number has been delivered. The dashboard presentation module 50 in FIG. 5 allows a user to correct or update the information shown in the module by interacting with the information presented such that if a job has been delivered or not delivered the user of the dashboard presentation module can make such an indication to an intelligent dashboard agent via the data management layer using buttons 52. The dashboard presentation module 50 in FIG. 5 displays information in real-time as indicated by the date and time 54 shown on the presentation module 50 at the top of the display.

FIG. 6 shows a dashboard presentation module 60 of an intelligent information dashboard system for a cutting tool service center. The presentation module 60 shown in FIG. 6 is another example of the present invention. This module 60 shows how various types of data sources and related information can be presented to a user so that the user viewing the dashboard presentation module can make decisions or take action based on the information.

FIG. 7 shows a dashboard presentation module 70 of an intelligent information dashboard system for a final assembly moving line of a 747 aircraft. This example of an intelligent information dashboard system of the present invention shows the extent to which different types of information and data can be presented on a dashboard presentation module. FIG. 7 shows images, text, numerical data and information, pie and bar charts, and line graphs. In addition to presenting information on the presentation module, the dashboard presentation module 70 shown in FIG. 7 allows the user to interact with the intelligent information dashboard system. A dashboard presentation module may provide a user with control of images that are available for presentation and control of text that may be displayed. For example, the presentation module of FIG. 7 may be used by a manager or other individual to create a display which others can view. A manager may be able determine what image and what text will be visible on presentation modules. The manager may be able to interact with the presentation module shown in FIG. 7 by selecting image control or text control and synchronizing the module with the requested information. The resulting presentation module may be available for others to view. An image previously recorded and being displayed on the module can be updated by interaction of the user with the presentation module. This presentation module has interaction controls that allows a user to click on a live button or to switch to another camera view. One of ordinary skill in the art will recognize that the present invention provides the capability of various iterations or presentation of the same information. Such as in the previously described example, the data selected by a manager or other user may be used to create a data tunnel for a presentation module available for others to access. As further described herein, by requiring credentials or authorization with an embodiment of the presentation invention, separate presentation modules may be designed for different purposes using the same data sources.

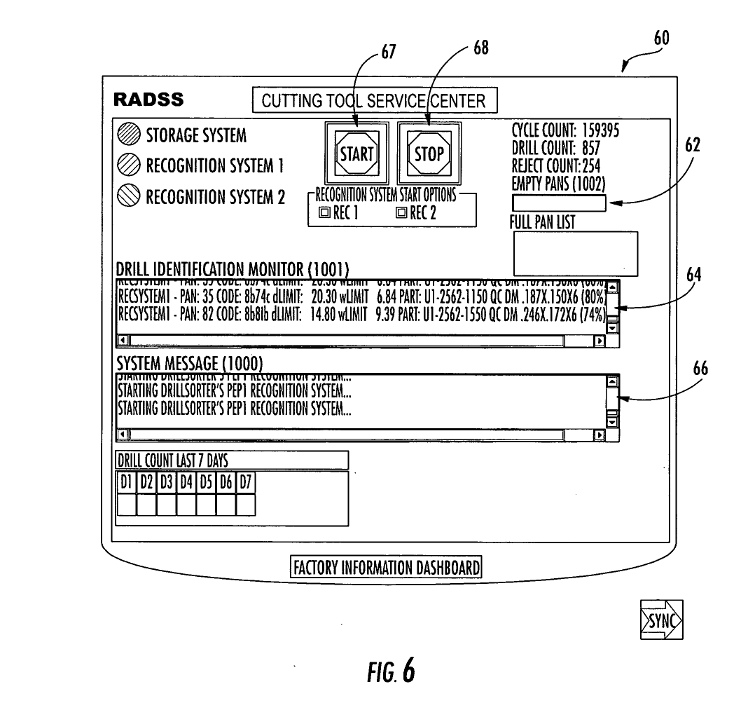

FIG. 8 shows a dashboard presentation module 80 of an intelligent information system for global positioning system (GPS) tracking. The presentation module 80 simply provides the user with a graphical map imported from a data source and a graphical icon of a truck showing the location of a shipment on the map. As the GPS information for the location of the truck changes and that data is provided by an intelligent dashboard agent to the dashboard management layer, the information presented on the dashboard presentation module 80 of FIG. 8 will similarly change to display the real-time location of the truck on a map.

FIG. 9 shows a visual design module 90 for an intelligent information dashboard system of the present invention. A designer of a dashboard presentation module can use a UDCS application visual designer to select and modify a dashboard presentation module. Shown in FIG. 9 are possible presentation objects, dynamic objects for presenting information. Shown in the upper left-hand corner of the visual designer are various forms of graphs and charts. On the right-side of the visual designer are different additional elements that can be used when designing a presentation module, such as buttons, text areas, and input fields. Additional dynamic objects such as tables, images, and tunnel buffered text areas can be included on a presentation module. The dynamic objects shown in FIG. 9 are only examples of different methods of presenting information on a presentation module.

The object of using a visual design tool such as that shown in FIG. 9 is to design a presentation module that presents information in a format a user can understand and use without being required to learn additional formats or presentation methods. A visual design application or tool is used to quickly put together each dashboard presentation module. Each dashboard object that is selected in the visual designer is controlled by the data that is presented by an intelligent dashboard agent to the data management layer and, in turn, to the data presentation layer.

FIG. 10 shows a block diagram of a universal data collection system 300 of a dashboard data management layer. The universal data collection system 300 of FIG. 10 is a hardware device and a software application that are composed to dynamically distribute and collect data. A universal data collection system may include a computer system with a processor, memory, and storage with hardware or software inputs and outputs for data from and to intelligent dashboard agents and hardware or software outputs and inputs for data to and from presentation modules. The computer system may be common with or distributed from a computer system of an intelligent dashboard agent layer or a dashboard presentation layer. The computer system may include software in the storage or memory that operates on the processor to tunnel and/or aggregate data from the intelligent dashboard agent layer to the dashboard presentation layer. The universal data collection system 300 of FIG. 10 includes a kernel 302 to administer the flow of data from intelligent dashboard agents 304, 306, 308, 310 to the dashboard presentation modules 312. A universal data collection system for the present invention may include a UDCS client application program interface (UDCS Client API) as well as UDCS software utilities such as an administrative tool. In FIG. 10, the data from a device is shown as being published by an intelligent dashboard agent as a UDCS data provider 304, 306, 308, 310 which produces information to the UDCS kernel 300 using the UDCS Client API. The UDCS kernel 300 subscribes the information to a UDCS data consumer 312, shown on the left side of FIG. 10, using the same UDCS Client API. The architecture of a UDCS is based entirely on the principle of producing and consuming data. Included in a universal data collection system of the present invention is the ability of the UDCS kernel 300 to collect or consume information from a UDCS service 310 which acts like a UDCS data provider. Thus, a universal data collection system of the present invention allows a consumer to interact with the intelligent dashboard agent system by providing data back to the UDCS kernel using the UDCS Client API. The data from a user's interaction can be subscribed to an intelligent dashboard agent, shown on the right side of FIG. 10 as a UDCS service provider 310, that can then subscribe to information and present that information or data to an external information device. This two-way communication is an advantageous feature of an intelligent information dashboard system of the present invention.

A universal data collection system can accept data of any type and from any source whether it be local or remote. Data can be published directly to a universal data collection system by UDCS hardware or through a computer system or network. In either case, a software agent, such as an intelligent dashboard agent, is developed to provide data to the UDCS. The developer of the agent would need to know how to read data from the device of interest, such as obtaining information from an analogue to digital converter, and then know how to use the UDCS Client API to make that data available to the UDCS so that the UDCS can dynamically provide the same data or information to a user by way of a dashboard presentation module.

Because a universal data collection system kernel treats data as a stream of bytes, a data source can publish data of any size and any type to a dashboard management layer. It is the responsibility of a data provider, and intelligent dashboard agent, to register the data tunnel description with the UDCS kernel. The UDCS Client API or UDCS administrative tool can be used to set or obtain a data description for each tunnel. Providing data and using data are not the function of the UDCS. The UDCS will accept data from data providers and ensure the delivery of that data to consumers. The UDCS kernel does not alter the data published by an intelligent dashboard agent.

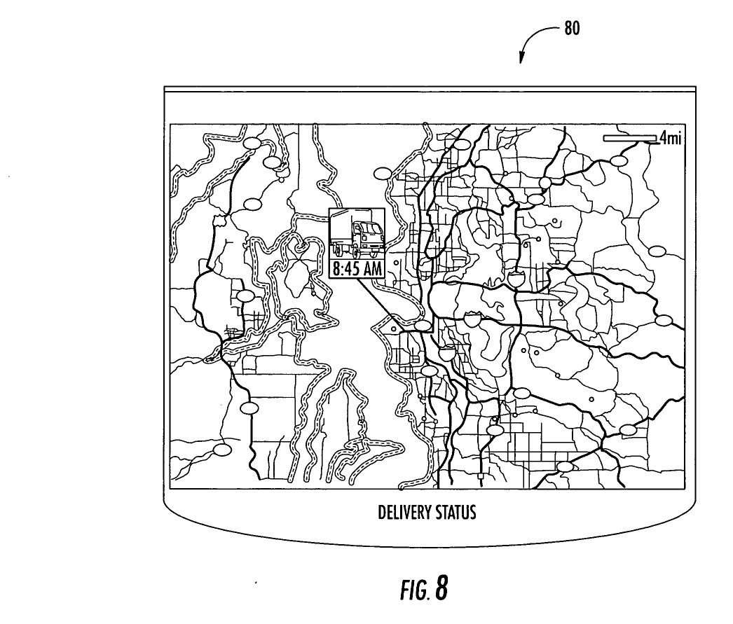

FIG. 11 shows a diagram of the security provided by a universal data collection system of the present invention. Each data tunnel can be password protected. Each data tunnel can have separate credentials, user name and password, that a dashboard presentation module must know in order to subscribe to the information provided by a data tunnel. As seen in FIG. 11, the data provider 320 enables a data valve 322 by creating an authentication 324 for the data tunnel 326, normally a password and user name. A data valve may be open or closed, on or off, either allowing transmission of the data or not. When a data consumer 330 or dashboard presentation module attempts to subscribe to the data tunnel 336, a data valve 332 requires the proper authentication 334 that matches the authentication 324 created by the intelligent dashboard agent. Without proper authentication a user is not capable of seeing the data or information presented by a data tunnel. This level of security allows a single universal data collection system to provide different data tunnels or different combinations of data tunnels to multiple users of an intelligent information dashboard system.

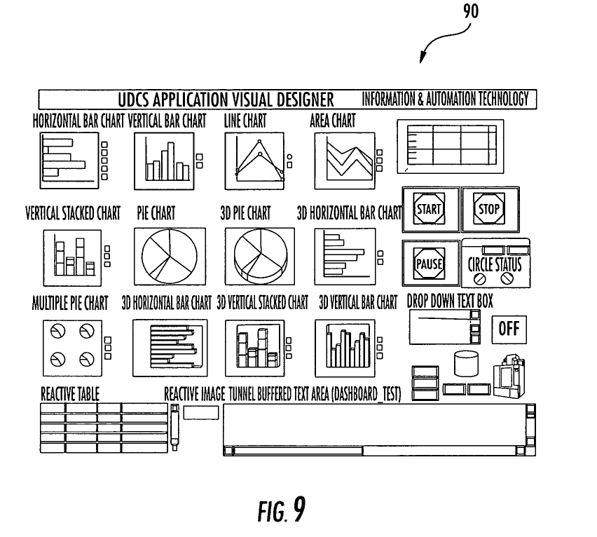

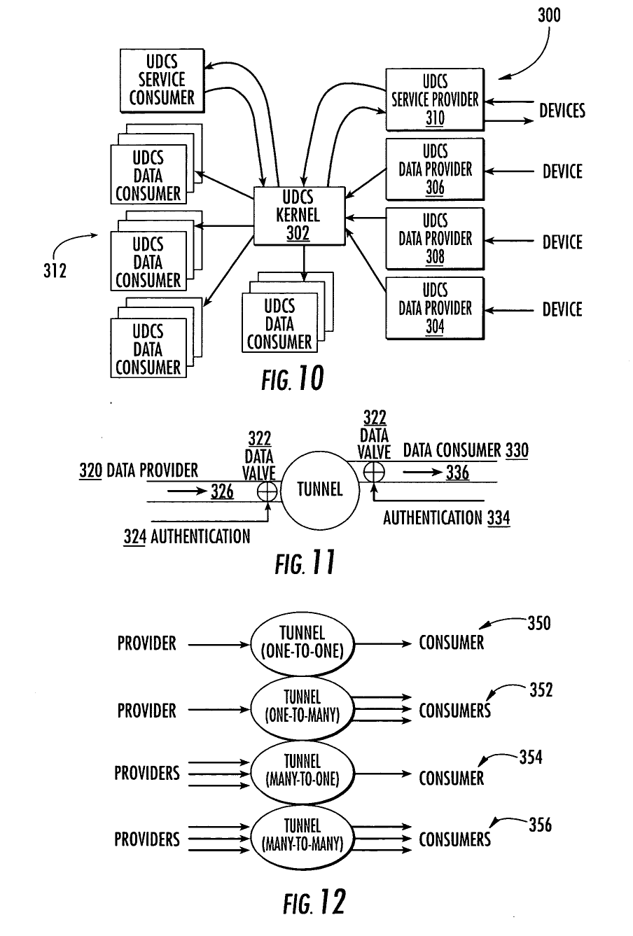

FIG. 12 shows a diagram of different types of data tunnel modes of operation. A one-to-one tunnel 350 is created where data is provided by a single source and subscribed to by a single user. A one-to-many data tunnel 352 is created where a single source provides information for multiple consumers. A many-to-one data tunnel 354 is created where multiple providers publish information that is subscribed to by a single consumer. The data from each of the individual data sources is aggregated by the UDCS. A many-to-many data tunnel 356 is created where multiple data sources are collected into an aggregated data tunnel and subscribed to by multiple consumers. These four modes of tunnel operation 350, 352, 354, 356 are examples of different methods by which information can be published or provided to a dashboard management layer and subscribed to from data presentation modules.

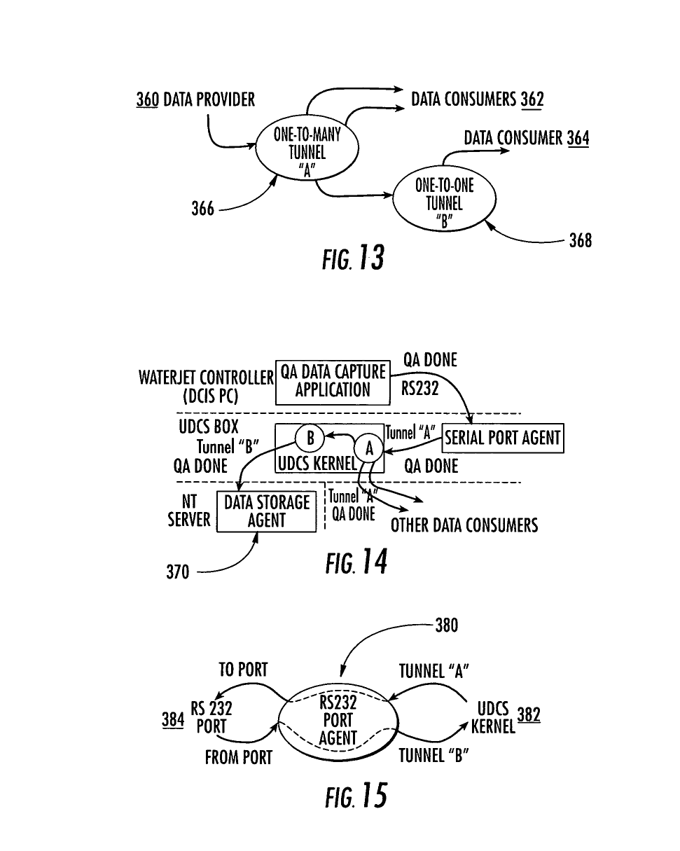

FIG. 13 shows a diagram of tunnel mirroring. One tunnel can mirror another tunnel. Shown in FIG. 13, Tunnel B 368 mirrors the data of Tunnel A 366 such that Tunnel B 368 is a read-only tunnel that is created to serve a particular process. Since Tunnel B 368 is a one-to-one tunnel, the data of Tunnel B is protected against loss due to network downtime during which a user cannot access the data. In the one-to-one mode of operation, the data of a tunnel is automatically buffered if the data consumer 364 is not connected to receive the data. The buffering of the data is provided to the extent that the data management buffer is able to hold data during the period the network is down and during which the data consumer cannot subscribe to and receive the data from the tunnel.

FIG. 14 is an example of tunnel mirroring shown in FIG. 13. The example in FIG. 14 is for a waterjet machine application. The data from Tunnel A is mirrored by Tunnel B. The data of Tunnel B is stored in a Data Storage Agent 370. Tunnel A is not protected against data loss.

FIG. 15 shows a diagram of a software agent or intelligent dashboard agent. A software agent is a UDCS software application designed to act on behalf of a device in dealing the UDCS kernel. A software agent can be a UDCS data provider, data consumer, or both data provider and data consumer. A software agent acts autonomously in the background without user interaction. For example, the RS232 port agent 380, software agent, in FIG. 15 is both a data provider and data consumer. The RS232 port agent 380 provides data to the UDCS kernel 382 via Tunnel B. The RS232 port agent 380 is a data consumer from the UDCS kernel 382 via Tunnel A. A data provider software agent needs to be able to read data from a data source and provide data to the UDCS kernel using the UDCS Client API. To be a data consumer, a software agent needs to be able to obtain data from the UDCS kernel using the UDCS Client API.

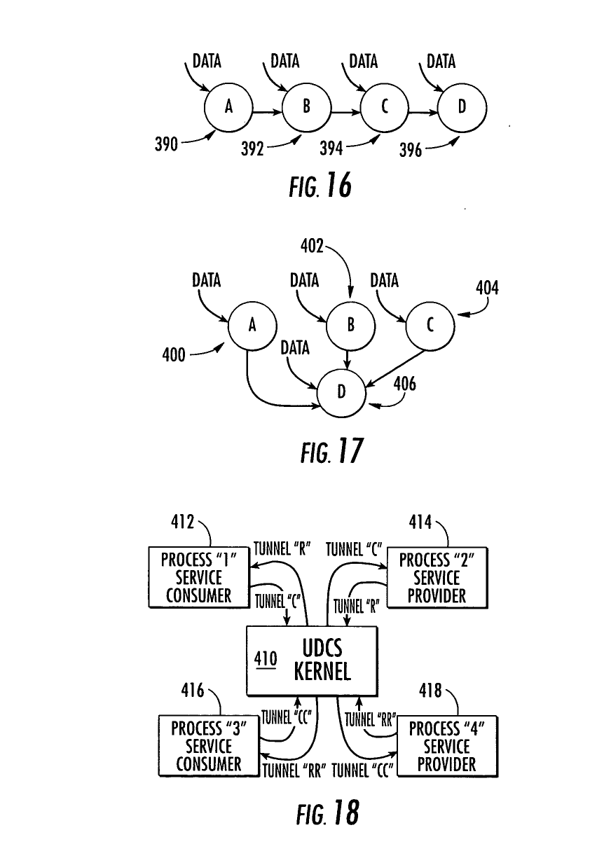

The universal data collection system of the present invention supports both synchronous and asynchronous data access. The UDCS Client API is capable of both processes. FIG. 16 is a diagram of a data driven sequential process, whereby data is published to Tunnel A 390 and required of Tunnel B 392 before Tunnel B 392 can be created. Similarly, Tunnel C 394 requires that Tunnel B 392 be in existence to create data Tunnel C 394. Data Tunnel D 396 requires that data is obtained from data Tunnel C 394, thus data Tunnel C 394 must be in existence before data Tunnel D 396 can be created. FIG. 17 is an example of a data driven random, or asynchronous, process. Data Tunnel D 406 does not require that data Tunnels A 400, B 402, and C 404 are created in any sequence, but only requires that data Tunnels A, B, and C exist before data Tunnel D 406 can be created.

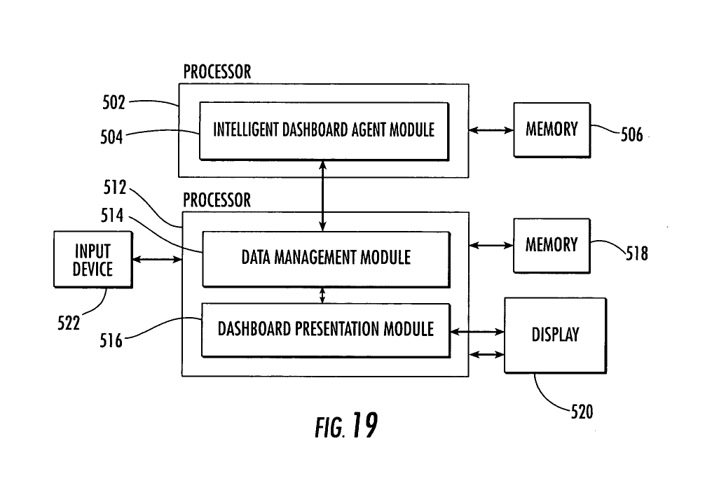

FIG. 18 shows a block diagram of data synchronization support of a universal data collection system of the present invention. Data synchronization occurs using a mechanism called UDCS service provider and UDCS service consumer. An intelligent dashboard agent uses UDCS service provider so that services can be invoked remotely by UDCS service consumer. These services are a way for a data consumer, and user of a dashboard presentation module, to tell a data provider or intelligent dashboard agent what to do, when to do it, and how to do things in the context of a data collection process. For example, one software process can use this mechanism to trigger the data flow from another software process. A data consumer must register all of the services it intends to provide using UDCS Client API. This registration is localized to the data provider. A data consumer must have prior knowledge of those services to know how to invoke them. Normally, the developer of UDCS service consumer and UDCS service provider is the same person; otherwise those services should be documented such that other developers would know how to use them. The UDCS service provider is mutually exclusive to a service consumer. While a service consumer is using the service provider, no other service consumers can access it. The service consumer can only serve one service at a time. In FIG. 18, Process 1 is a service consumer 412 and Process 2 is a service provider 414. Tunnel C, representing the command tunnel from the service consumer 442, is published by Process 1 service consumer 412 to the UDCS kernel 410 and subscribed to by Process 2 service provider 414. Tunnel R, representing the response tunnel, is published by Process 2 service provider 414 to the UDCS kernel 410 and subscribed to by the Process 1 service consumer 412. A similar UDCS service provider and UDCS service consumer method is shown on the bottom of FIG. 18.

As shown in FIG. 19, an embodiment of a system of the present invention may be embodied by a processors 502, 512 and associated memory devices 506, 518, which are commonly comprised by a computer or the like. In this regard, as indicated above, information presentation systems, data systems, methods, and computer systems of embodiments of the present invention can use processors 502, 512 manipulating software and data stored by the memory devices 506, 518 to operate intelligent dashboard agent modules 504, data management modules 514, and dashboard presentation modules 516. A computer can include a display 520 for presenting information relative to performing embodiments of the present invention and input device(s) 522 for accepting input from a user or other external source. The embodiment shown in FIG. 19 includes two processors 502, 512 where the processor 502 for the intelligent dashboard agent module 504 is interconnected with but distributed from the processor 512 for the data management module 514 and the dashboard presentation module 516. Processors, and memory and other devices, for each of these layers of the present invention may be common or distributed, part of the same or multiple platforms. Similarly, as the present invention incorporates functionality for a plurality of intelligent dashboard agent modules and dashboard presentation module, one of ordinary skill in the art will recognize that processors for additional modules, not shown, may be interconnected with the data management module 514 or processors for additional modules, not shown, may be common with processors for other modules or the data management module 514.

According to one aspect of the present invention, the system of the present invention generally operates under control of a computer program product according to another aspect of the present invention. The computer program product for performing the information presentation systems, data systems, methods, and computer systems of embodiments of the present invention includes a computer-operable processing element, such as the processor 502, 512, and a computer-readable storage medium, such as the memory device 506, 518, and computer-readable program code, such as a series of computer instructions but not shown, embodied in the computer-readable storage medium.

In this regard, FIG. 1 is a flowchart of an intelligent information dashboard system according to the present invention, representative of information presentation system, data system, method, computer program product, and computer system embodiments of the present invention. It will be understood that each block, or step, or element of the flowchart, and combinations of blocks and/or elements in the flowchart, can be implemented by computer program instructions. These computer program instructions may be loaded onto a computer or other programmable apparatus to produce a machine, such that the instructions which execute on the computer or other programmable apparatus create means for implementing the functions specified in the flowchart block(s) or element(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or element(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart block(s) or element(s).

Accordingly, blocks or elements of the flowchart support combinations of means for performing the specified functions, combinations of steps for performing the specified functions and program instruction means for performing the specified functions. It will also be understood that each block or element of the flowchart, and combinations of blocks and/or elements in the flowchart, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A information presentation system comprising:
at least one intelligent dashboard agent module;
a data management module interoperably connected to the at least one intelligent dashboard agent module; and
at least one dashboard presentation module interoperably connected to the data management module.

2. The information presentation system of claim 1, wherein the at least one dashboard presentation module is a web-based application.

3. The information presentation system of claim 2, wherein the at least one dashboard presentation module is capable of presenting data or information in real-time.

4. The information presentation system of claim 1, wherein the at least one dashboard presentation module is capable of accepting input through a user input device or presentation module logic and providing a first signal based upon the input or logic to the data management module.

5. The information presentation system of claim 4, wherein the input is a correction, update, or selection of information.

6. The information presentation system of claim 4, wherein the data management module is capable of providing a second signal based upon the first signal to at least one intelligent dashboard agent module.

7. The information presentation system of claim 6, wherein said second signal is a command signal to control a manufacturing process or to adapt a business system.

8. The information presentation system of claim 4, wherein the data management module is capable of providing a third signal based upon the first signal to an external information device.

9. The information presentation system of claim 8, wherein the external information device is at least one selected from the group of a pager, a cellular phone, an email account, a wireless personal digital assistant, and an operator terminal.

10. The information presentation system of claim 8, wherein the data management module provides the third signal to the external information device by a transmission medium selected from the group of a wireline connection or a wireless transmission.

11. The information presentation system of claim 1, wherein the data management module is capable of propagating data from at least one intelligent dashboard agent module to at least one dashboard presentation module.

12. The information presentation system of claim 11, wherein the data management module is capable of establishing at least one data tunnel

13. The information presentation system of claim 12, wherein the data management module requires a password for the at least one dashboard presentation module to subscribe to at least one password-protected data tunnel.

14. The information presentation system of claim 12, wherein first and second dashboard presentation modules subscribe to at least one common and at least one different data tunnel.

15. The information presentation system of claim 1, wherein the data management module is capable of aggregating data from at least one intelligent dashboard agent module.

16. The information presentation system of claim 15, wherein the data management module is capable of establishing:
at least one data tunnel; and
at least one aggregated data tunnel, wherein the at least one aggregated data tunnel is generated by aggregating data from at least two data tunnels.

17. The information presentation system of claim 16, wherein a first hyper-aggregated data tunnel is generated by aggregating data from the at least one aggregated data tunnel and from at least a second data tunnel or aggregated data tunnel.

18. The information presentation system of claim 1, wherein the at least one intelligent dashboard agent module is capable of collecting and processing data.

19. The information presentation system of claim 18, wherein the at least one intelligent dashboard agent module processes data by filtering collected data or computing resultant data from collected data.

20. The information presentation system of claim 18, wherein the at least one intelligent dashboard agent module is capable of formatting data.

21. The information presentation system of claim 18, wherein the at least one intelligent dashboard agent module collects data from a manufacturing process or a business system.

22. The information presentation system of claim 21, wherein said business system is a security system.

23. The information presentation system of claim 1, further comprising:
a visual design module capable of selecting and organizing data and presentation objects and elements to create the at least one dashboard presentation module.

24. The information presentation system of claim 23, wherein the visual design module is capable of formatting selected data for presentation on the at least one dashboard presentation module.

25. A data system for a computer system having a plurality of functional layers, the data system comprising:
a data management module comprising a universal data collection system; and
at least one intelligent dashboard agent module interoperably connected to the data management module comprising at least one device or business data source.

26. The data system of claim 25, wherein the universal data collection system comprises a software kernel capable of administering the flow of data from data sources of an intelligent dashboard agent module and the data management module.

27. The data system of claim 26, further comprising a presentation module interoperably connected to the data management module.

28. The data system of claim 27, wherein the software kernel is capable of administering the flow of data from data sources of an intelligent dashboard agent module, through the data management module, to the presentation module.

29. The data system of claim 28, wherein the software kernel is capable of administering the flow of data from the presentation module, through the data management module, to an intelligent dashboard agent module.

30. The data system of claim 28, wherein the software kernel is capable of administering the flow of data from the presentation module, through the data management module, to an external information device.

31. The data system of claim 30, wherein the external information device is at least one selected from the group of a pager, a cellular phone, an email account, a wireless personal digital assistant, and an operator terminal.

32. The data system of claim 25, wherein the universal data collection system is capable of establishing at least on data tunnel through which data from at least one data source flows.

33. The data system of claim 32, wherein at least one data tunnel comprises an incoming data flow data valve.

34. The data system of claim 32, wherein at least one data tunnel comprises an outgoing data flow data valve.

35. The data system of claim 32, wherein a first data tunnel mirrors a second data tunnel.

36. The data system of claim 25, wherein the universal data collection system synchronizes data from a first data source with data from a second data source.

37. A method of providing intelligent information comprising the steps of:
collecting data from at least one source using at least one of a plurality of intelligent dashboard agent modules;
managing acquisition of the data that is collected using a data management module;
designing at least one presentation module for displaying the acquired data; and
displaying the acquired data on the at least one presentation module.

38. The method of claim 37, further comprising the step of formatting the data that is collected.

39. The method of claim 37, further comprising the step of designing the at least one presentation module to process the acquired data.

40. The method of claim 37, further comprising the step of:
accepting input to the at least one presentation module from an input device.

41. The method of claim 40, further comprising the steps of:
generating an input signal within the presentation module based upon the input by the input device; and
passing the input signal generated by the presentation module to the data management module.

42. The method of claim 41, further comprising the steps of:
generating a response signal within the data management module based upon the input signal; and
passing the response signal generated by the data management module to an external information device or to an intelligent dashboard agent module.

43. The method of claim 39, further comprising the steps of:
generating a processing signal within the presentation module based upon the processing of the acquired data by the presentation module; and
passing the processing signal generated by the presentation module to the data management module.

44. The method of claim 43, further comprising the steps of:
generating a response signal within the data management module based upon the processing signal; and
passing the response signal generated by the data management module to an external information device or to an intelligent dashboard agent module.

45. The method of claim 37, wherein the step of managing acquisition of the data comprises the step of aggregating collected data from at least two sources to create an aggregated data tunnel.

46. The method of claim 45, wherein the step of managing acquisition of the data further comprises the step of hyper-aggregating collected data from at least one aggregated data tunnel with collected data from another source or with another aggregated data tunnel to create a hyper-aggregated data tunnel.

47. A computer program product comprising a computer-useable medium having a computer-readable code embodied therein for presenting information on a computer display screen, the computer-readable code comprising:
a first intelligent agent code for collecting data from at least one source;
a second data management code for managing acquisition of the data that is collected;
a third design code for designing a presentation module for displaying the acquired data; and
a fourth presentation code for displaying the acquired data on the presentation module.

48. The computer program product of claim 47, wherein the first intelligent agent code comprises code for formatting the data that is collected

49. The computer program product of claim 47, wherein the fourth presentation code comprises code for processing the acquired data by the presentation module.

50. The computer program product of claim 47, wherein the fourth presentation code comprises code for accepting input to the presentation module.

51. The computer program product of claim 50, wherein the fourth presentation code comprises code for generating an input signal based upon the input and code for passing the input signal to the second data management code.

52. The computer program product of claim 51, wherein the second data management code comprises code for generating a response signal based upon the input signal and code for passing the response signal to an external information device or to an intelligent dashboard agent module.

53. The computer program product of claim 49, wherein the fourth presentation code comprises code for generating a processing signal based upon the processing of the acquired data and code for passing the processing signal to the second data management code.

54. The computer program product of claim 53, wherein the second data management code comprises code for generating a response signal based upon the processing signal and code for passing the response signal to an external information device or to an intelligent dashboard agent module.

55. The computer program product of claim 47, wherein the second data management code comprises code for aggregating collected data from at least two sources to create an aggregated data tunnel.

56. The computer program product of claim 55, wherein the second data management code comprises code for hyper-aggregating collected data from at least one aggregated data tunnel with collected data from another source or with another aggregated data tunnel to create a hyper-aggregated data tunnel.

57. A computer system used to present information comprising:
at least one agent module that collects data from a source coupled to a intelligent agent processor, wherein the intelligent agent processor is operative to collect data;
a management module that acquires the data from at least one agent module coupled to a data management processor, wherein the data management processor is operative to manage data;
at least one presentation module that displays the data on the display device coupled to a presentation processor, wherein the presentation processor is operative to display data and is coupled to a display device; and
at least one memory for storing data coupled to the intelligent agent, data management, or presentation processor.

58. The computer system of claim 57, wherein at least two of the intelligent agent, data management, and presentation processors are the same processor.

59. The computer system of claim 58, wherein the management module comprises a universal data collection system interoperably coupled to the at least one agent module and to the at least one presentation module.

60. The computer system of claim 58, wherein the management module comprises at least one data tunnel for transferring data from an agent module to the data management module.
